(19) United States
(12) Patent Application Publication
(10) Pub. No.: US 2011/0198287 A1
(43) Pub. Date: Aug. 18, 2011

(54) Spiral Wound Hollow Fiber Membrane Module for Membrane Distillation

(75) Inventors: Simon Paul Dukes, Chelmsford, MA (US); Chan Mya Tun, Baulkham Hills (AU)

(73) Assignee: SIEMENS AKTIENGESELLSCHAFT, Munich (DE)

(21) Appl. No.: 13/025,456

(22) Filed: Feb. 11, 2011

Related U.S. Application Data
(60) Provisional application No. 61/305,791, filed on Feb. 18, 2010.

(51) Int. Cl. B01D 61/36; B01D 53/22; C02F 1/04; B01D 3/00; B01D 63/00; B01D 69/08

(52) U.S. Cl. 210/640; 210/486; 210/487; 210/321.88; 210/185; 202/200; 210/163

(57) ABSTRACT

Membrane modules, and contactor apparatuses that utilize these modules, comprise a membrane contactor layer and a condenser region and optionally a core. The modules comprise a membrane contactor layer comprising a membrane envelope and a plurality of hollow fiber membranes disposed therein; a feed fluid pathway defined at least in part by lumens of the hollow fibers; and a permeate fluid pathway defined at least in part by an interstitial space between outer surfaces of the hollow fibers and inner surfaces of the membrane envelope.

### CROSS-REFERENCE TO RELATED ED APPLICATIONS

This application claims priority under 35 U.S.C. §119(e) to U.S. Patent Application Ser. No. 61/305,791, filed Feb. 18, 2010, which is hereby incorporated by reference in its entirety as if fully set forth below.

### FIELD

Embodiments of the present invention relate to membrane modules, and in particular to membrane modules used in membrane contactor applications such as membrane distillation.

### BACKGROUND

Synthetic polymeric membranes are well-known in the field of ultrafiltration and microfiltration for a variety of applications, including desalination, gas separation, filtration and membrane contactor applications, including membrane distillation.

Membrane distillation is a process that has been investigated as a low cost, energy saving alternative to conventional separation processes, such as distillation and reverse osmosis. Both membrane distillation and conventional distillation rely on vapor-liquid equilibrium as a basis for separation. Further, both processes require that the latent heat of vaporisation be supplied to achieve the characteristic phase change.

Membrane distillation is a separation method in which a nonwetting, microporous membrane is used with a liquid feed phase on one side of the membrane and a condensing, permeate phase on the other side. The condensing phase may be a gas, such as air, or a liquid that may be the same as or different from the distillate. Separation by membrane distillation is based on the relative volatility of various components in the feed solution. The driving force for transport is the partial pressure difference across the membrane. Separation occurs when vapor from components of higher volatility passes through the membrane pores by a convective or diffusive mechanism, while components of lower volatility do not pass through the membrane. A volatile compound can be thus obtained in a pure state by relatively low energy passage across a membrane.

The benefits of membrane distillation compared to conventional separation processes include complete theoretical rejection of ions, macromolecules and cells and lower operating temperature and pressure. Conventional distillation relies on high vapor velocities to provide intimate vapor-liquid contact. Membrane distillation uses a hydrophobic microporous membrane to support a vapor-liquid interface. Because lower vapor velocities are required, membrane distillation equipment can be designed on a much smaller scale than conventional distillation apparatus. Further, lower temperatures and pressures are required for membrane distillation, as it is not necessary to heat process liquids above their boiling temperature. This results in both equipment construction and operational cost savings. As a thermally driven process, membrane distillation has operating pressures in the order of zero to a few hundred kPa, which is relatively low compared to pressure driven processes such as reverse osmosis.

Despite these benefits, membrane distillation also has several limitations which have limited its commercial acceptance. Low water flux (i.e. low productivity) has been a barrier to commercialization of membrane distillation generally.

To be commercially attractive, membrane distillation processes require high rates of heat and mass transfer between the bulk solution and the solution membrane interface. Membrane distillation is generally limited by the heat and mass transfer resistance in the boundary layers. A module used in a membrane distillation process requires good mass-transfer properties, a comparatively modest energy requirement, and large membrane surface area per unit volume such that it can produce reasonable product volumes and operate at a sufficiently low cost.

Hollow fiber membrane configurations have been investigated for use in membrane distillation as a way of achieving high surface areas per unit volume but have not been used extensively because the method of fabrication of a hollow fiber membrane module is expensive and complex.

### SUMMARY

Briefly described, embodiments of the present invention relate to membrane modules, as well as contactor apparatuses that utilize these modules that comprise a membrane contactor layer and a condenser region and optionally a core. Methods of making and using the same are also provided.

According to a first aspect, the membrane module comprises: a membrane contactor layer comprising a membrane envelope and a plurality of hollow fiber membranes disposed therein; a feed fluid pathway defined at least in part by lumens of the hollow fibers; and a permeate fluid pathway defined at least in part by an interstitial space between outer surfaces of the hollow fibers and inner surfaces of the membrane envelope.

The membrane module can further comprise a condenser region adjacent to the membrane contactor layer. The membrane contactor layer and the condenser region can share a common wall capable of transferring heat. The membrane envelope can be formed of impermeable material for embodiments where coolant flowing in the condenser region is to be kept separate from permeate passing through the hollow fiber membrane walls. Alternatively, the membrane envelope can comprise a mesh screen for embodiments permeate fluid can flow into both the interstitial spaces and the condenser region, thereby enabling collection of product into the permeate fluid.

In one or more embodiments, the membrane contactor is spiral wound and the condenser region is defined by a space between respective windings of the membrane envelope. The condenser region can comprise one or more spacer sheets to space apart the respective windings of the membrane envelope.

Another embodiment provides that first ends of the lumens are in fluid communication with an inlet feed manifold and second ends of the lumens are in fluid communication with an exit feed manifold. Generally, the inlet feed manifold introduces a product-rich feed steam to the lumens and the exit feed manifold removes a product-depleted feed stream from the lumens.

One or more embodiments provides that the permeate fluid pathway is in fluid communication with a flowpath for distillate collection. The permeate fluid pathway may be in fluid communication with a flowpath at each respective end of the interstitial space. That is, the permeate fluid pathway may be in fluid communication with both the flowpath for distillate collection and an inlet permeate manifold. An inlet permeate manifold can introduce a product-poor permeate stream to the permeate fluid pathway and the flowpath for distillate collection can remove a product-rich permeate stream from the permeate fluid pathway.

The condenser region can comprise a condenser inlet, a condenser outlet, and a coolant pathway therebetween. As desired, the condenser region can comprises one or more internal baffles to provide a tortuous coolant pathway. The tortuous coolant path can traverse substantially all the condenser. The tortuous coolant pathway is provided by glue lines on one or more spacer sheets or on exterior surfaces of the membrane envelope, or both.

In a further embodiment, the membrane contactor layer is spiral wound about a central core. In one embodiment, the central core comprises an inlet coolant conduit for introducing coolant to the condenser region and an outlet coolant conduit for removing coolant from the condenser region. The central core may also contain an inlet permeate conduit for introducing a product-poor permeate stream into the interstitial space and an outlet permeate conduit for removing product-rich permeate from the interstitial space.

One or more embodiments provides that at least a portion of the coolant conduits, the permeate conduits, and the distillate conduit are coaxial.

In use, the hollow fiber membrane envelope can be mounted vertically during operation to allow for gravity drain of the distillate or product-rich permeate.

In a specific aspect, provided are membrane distillation apparatuses comprising any membrane module described herein located in a shell having a feed inlet in fluid communication with first ends of the lumens and a feed exit in fluid communication with second ends the lumens.

According to a second aspect, a method of making a membrane module for use in membrane contactor applications comprises: forming a mat of hollow fiber membranes; positioning the mat of hollow fiber membranes in a membrane envelope; substantially sealing the membrane envelope around the mat of hollow fiber membranes to form a feed fluid pathway defined at least in part by lumens of the hollow fiber membranes and a permeate fluid pathway defined at least in part by interstitial spaces between outer surfaces of the hollow fiber membranes and inner surfaces of the membrane envelope; and spiral winding the membrane envelope to define a condenser region between respective windings of the membrane envelope.

The method can further comprise including one or more spacer sheets in the condenser region to space apart the respective windings of the membrane envelope.

In one embodiment, the method further comprises providing apertures in at least one end of the membrane envelope to allow egress of distillate from the interstitial space.

In another embodiment, the method further comprises providing apertures in at least two opposed ends of the membrane envelope to allow passage of a permeate fluid through the interstitial space.

The method can comprise the step of applying one or more glue lines on one or more spacer sheets or on exterior surfaces of the membrane, or both prior to spiral winding to form a tortuous coolant path within the condenser region.

In one embodiment, the method comprises the step of applying one or more glue lines to the spacer sheet to prior to spiral winding to predefine a flowpath between respective windings of the membrane envelope. The flowpath may be a distillate removal conduit between respective windings of the membrane envelope.

The method can comprise winding the membrane envelope and condenser to define a plurality of interleaved contactor and condenser regions. A detailed embodiment provides that the method comprises spiral winding the membrane envelope and the spacer sheet(s) as applicable around a central core.

According to a third aspect, a method of using a hollow fiber module in membrane distillation comprises: passing a feed fluid comprising a vapor product and a carrier liquid into lumens of a plurality hollow fiber membranes disposed in a membrane envelope; collecting the vapor product that crosses the hollow fiber membranes from the feed fluid into an interstitial space defined by outer surfaces of the hollow fiber membranes and inner surfaces of the membrane envelope; and removing an exit stream that contains less product than the feed fluid from the lumens.

On or more embodiments provides that the feed fluid is at a temperature that is greater than ambient. In one embodiment, the method further comprises condensing the vapor product and removing it (as distillate). The condensing step can comprise contacting the membrane envelope with a coolant. Usually the step of removing the condensed vapor product comprises flowing it out of the module under gravity.

In an alternative embodiment, though, the step of removing the condensed vapor product can comprise flowing the condensed vapor product in a product-poor permeate stream.

As desired, the feed fluid can be fed into the membrane module under gravity (i.e., at the top of the apparatus) or under pressure (allowing feed at the bottom of the apparatus).

Generally, the coolant exits the condenser region at a temperature higher than a temperature at which it entered the condenser region, and the feed fluid exits the hollow fiber membranes at a temperature lower than a temperature at which it entered the hollow fiber membranes.

According to a fourth aspect, a method of using a hollow fiber module in membrane distillation comprises: passing a feed fluid comprising a vapor product and a carrier liquid into an interstitial space defined by outer surfaces of hollow fiber membranes and inner surfaces of a membrane envelope in which the hollow fiber membranes are disposed; collecting the vapor product that crosses the hollow fiber membranes from the feed fluid into lumens of the hollow fiber members; and removing an exit stream that contains less product than the feed fluid from the interstitial space.

The step of collecting the vapor product can comprise condensing the vapor into a permeate fluid which flows through the lumens. Alternatively, the step of collecting the vapor product can comprise removing the vapor product from the module to allow for condensation in a process external to the module.

According to a fifth aspect, a membrane contactor apparatus comprises: a plurality of membrane modules comprising: a respective plurality of a membrane contactor layers each comprising a membrane envelope and a plurality of hollow fiber membranes disposed therein; a respective plurality of feed fluid pathways defined at least in part by lumens of the hollow fibers; and a respective plurality of permeate fluid pathways defined at least in part by interstitial spaces between the respective outer surfaces of the hollow fibers and the respective inner surfaces of the membrane envelopes.

The configurations of the membrane contactor layers, the condenser regions, and the optional central core may be as described above for embodiments that possess a single spiral wound membrane contactor with an interleaved condenser region or flowpath.

According to a sixth aspect methods of making a membrane contactor apparatus comprising a plurality of membrane modules are provided.

The methods of providing a plurality of membrane modules are analogous to those described above in the case where a single membrane envelope is provided.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of ‘including, but not limited to’.

### BRIEF DESCRIPTION OF THE DRAWINGS

Embodiments will now be described, by way of example only, with reference to the accompanying drawings in which:

FIG. 1 is a schematic of a membrane module showing how a membrane contact layer comprising a membrane envelope is spiral wound with a spacer sheet or mesh about a central core to create a helically interleaved condenser or flowpath region between respective windings;

FIG. 2 shows a schematic of the arrangement of the membrane envelope, the spacer mesh, and the core in a first embodiment;

FIG. 3 shows a schematic of the assembly of the membrane contactor layer in a first embodiment;

FIG. 4 shows a cross section of the assembly of the membrane contactor layer comprising the membrane envelope in a first embodiment;

FIG. 5 shows a diagram of fluid pathways of the membrane envelope in an exploded view of a first embodiment;

FIG. 6 shows a schematic of the application of the spacer mesh to the membrane envelope in a first embodiment;

FIG. 7 shows a schematic of exemplary glue lines prior to winding in a first embodiment;

FIG. 8 shows a diagram of how the glue lines control flow in the condenser or flowpath region in a first embodiment;

FIG. 9 shows a schematic of the membrane module being assembled with the membrane envelope, the spacer mesh, and the core in a first embodiment;

FIG. 10 shows a diagram of the flow of fluids within the membrane module in a first embodiment;

FIG. 11 depicts the winding of layers in a first embodiment;

FIG. 12 shows a membrane contactor apparatus in a first embodiment;

FIG. 13 shows a diagram of fluid pathways of the membrane envelope in an exploded view of another embodiment;

FIG. 14 shows a schematic of exemplary glue lines for another embodiment prior to winding;

FIG. 15 shows a schematic of the membrane module being assembled with the membrane envelope, to the spacer mesh, and the core in another embodiment;

FIG. 16 shows a diagram of the flow of fluids within the membrane module in another embodiment; and

FIG. 17 shows a membrane contactor apparatus in another embodiment.

### DETAILED DESCRIPTION

Before describing several exemplary embodiments, it is to be understood that the invention is not limited to the details of construction or process steps set forth in the following description. The invention is capable of other embodiments and of being practiced or being carried out in various ways.

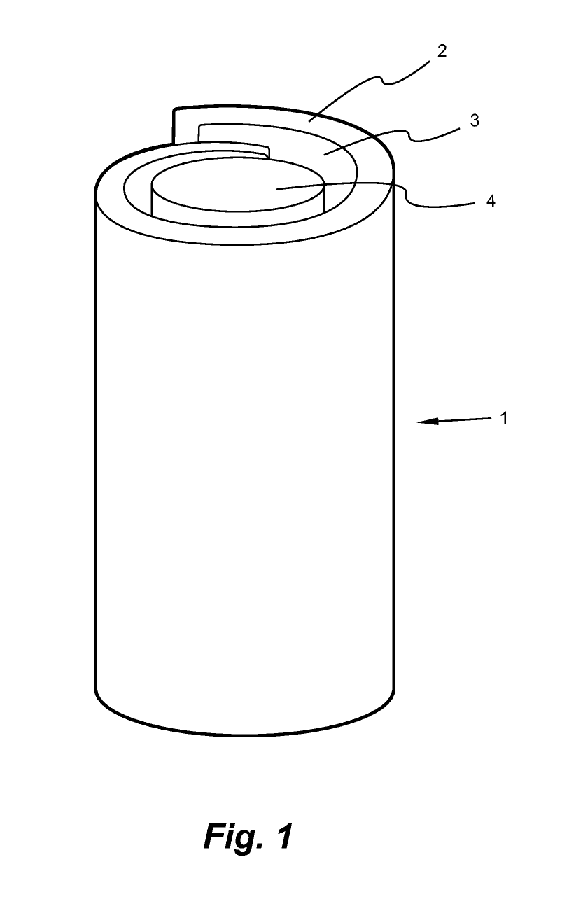

Embodiments of the present invention relate to membrane modules for use in membrane contactor applications such as membrane distillation. Turning to the figures, FIG. 1 shows a section of a membrane module 1 which generally has a membrane contactor layer 2 in contact with a condenser or flowpath region or layer 3, with the two layers optionally being attached to a central core 4 that is elongated. Condenser or flowpath region or layer 3 is defined by and lies within respective windings of a membrane envelope of the membrane contactor layer 2. The core or central core 4 is in fluid communication with the condenser region 3 in that the central core 4 controls the flow of coolant into and out of the condenser region 3 as well as the flow of permeate (either as distillate alone or with a permeate fluid) out of (and into as desired in certain embodiments) the condenser region 3. The membrane contactor layer 2 is spiral wound about the long axis of the central core 4 in a rolled manner, sometimes referred to as “Swiss Roll” fashion, so that any cross-section along a radial plane shows an alternating arrangement of the membrane contactor layer 2 and the resulting condenser region 3.

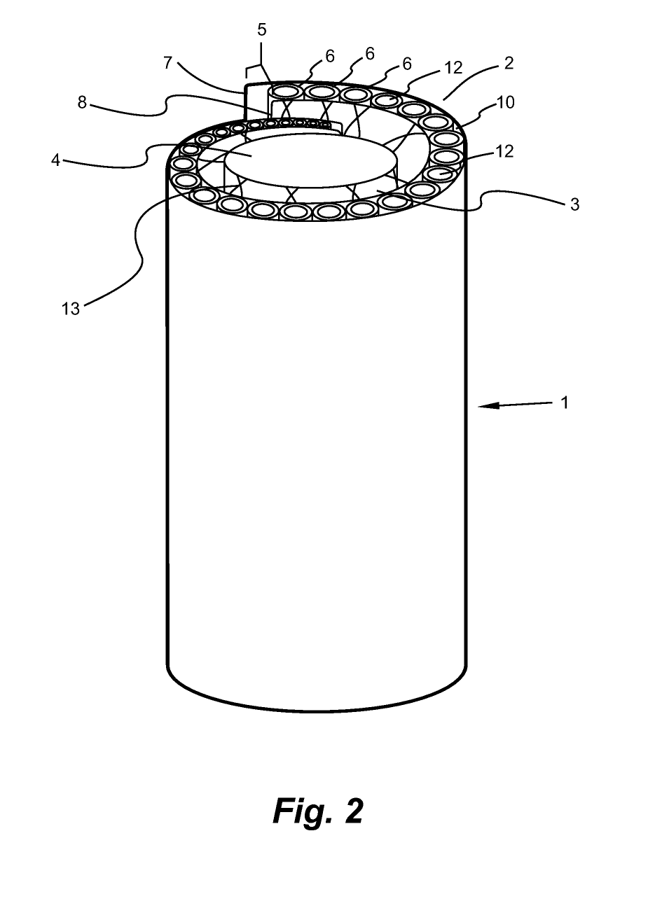

FIG. 2 is a cross-sectional view of the membrane module, which shows more particularly the arrangement of hollow fiber membranes and spacer sheets within the membrane contactor layer 2 and the condenser region 3.

The membrane contactor layer 2 comprises a membrane envelope 5 surrounding a mat (also known as a web or packet or bundle) of hollow fiber membranes 6 that define lumens 12. The hollow fiber membranes are arranged in the mat longitudinally and substantially parallel. This mat is then disposed within one or two (or more) impermeable sheets, 7, 8, which form the membrane envelope. Sheets 7 and 8 may be part of one larger sheet that is folded over. This arrangement gives rise to an interstitial space 10 or plurality of interstitial spaces 10 between the outside of the hollow fiber membranes and the inner faces or surfaces of the impermeable sheets 7, 8. The lumens 12 define a feed fluid pathway for a feed fluid to travel through the membrane module. The interstitial space 10 defines a permeate fluid pathway for permeate containing the desired product that was separated out of the feed fluid to be collected and condensed.

Condenser region 3 can comprise a spacer sheet (or mesh) 13, which separates the windings of the membrane envelope 5 of the membrane contactor layers. The spacer sheet or mesh, which can be one or multiples leaves of material to form a desired thickness and volume/area for cooling, enables the space between the respective windings of the membrane envelope 5 to function as a condenser region or flowpath layer 3. The spacer sheet or mesh 13 can keep the windings of the membrane envelope apart, and also allow fluid to move around readily in the space of the windings.

Two possible embodiments using this general principle of construction are described herein.

A first embodiment allows for condensation of neat vapor product that permeates the hollow fiber membrane walls and collection of this neat product from the interstitial space of the membrane envelope. In this first embodiment, the membrane envelope is desirably formed from one or more impermeable membranes in order to keep the condenser region separated from the interstitial space.

A second embodiment allows for the use of a permeate fluid that collects vapor product as it passes through the hollow fiber membrane walls. The permeate fluid becomes enriched with the vapor product (or distillate), which means that if the permeate fluid and distillate are different, the concentration of distillate in the permeate fluid can rise as the permeate fluid passes through the interstitial space 10. But if the permeate fluid and distillate are the same, for example if the permeate fluid is water and the distillate is water, then the concentration of course cannot change but the enrichment may manifest itself as an increase in the amount of water on the distillate side of the membrane. As desired in this second embodiment, the membrane envelope can comprise one or more mesh screens to create substantially fully turbulent fluid flow in the area of the interstitial space and condenser region.

Although embodiments of the invention have been illustrated with respect to a single spiral wound membrane module for use in membrane contactor applications, it would be possible to use two or more membrane modules in an analogous fashion, to create two or more discrete spiral paths. The advantage of using multiple membrane modules is that the path length from the core to the outer end of the membrane is reduced, thereby allowing for potentially better control over the hydraulics of the system.

### Example 1

### Distillate Removal

In the first embodiment, a membrane module can be used to distill a volatile product across a membrane and collect the neat distillate.

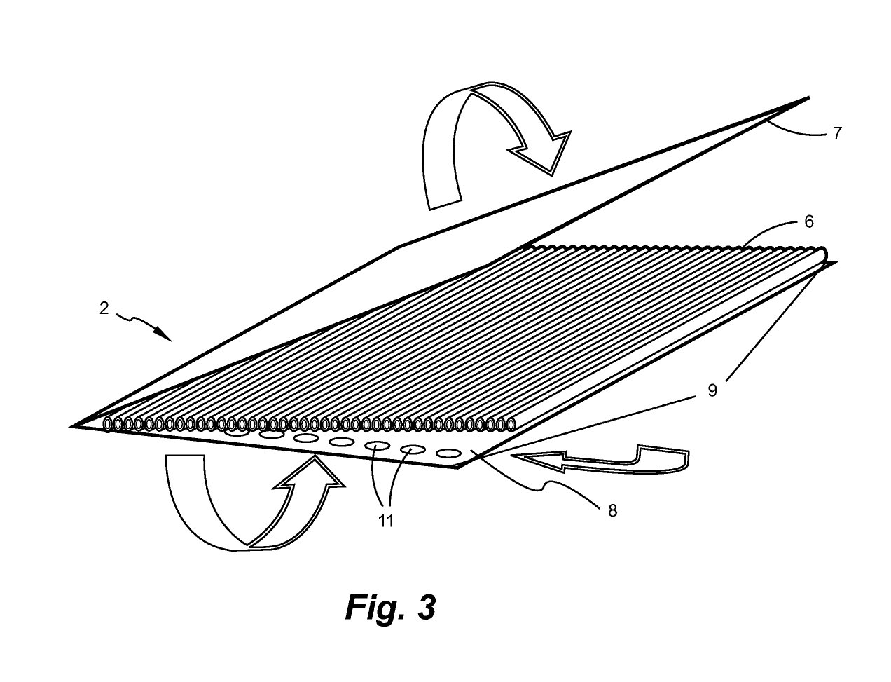

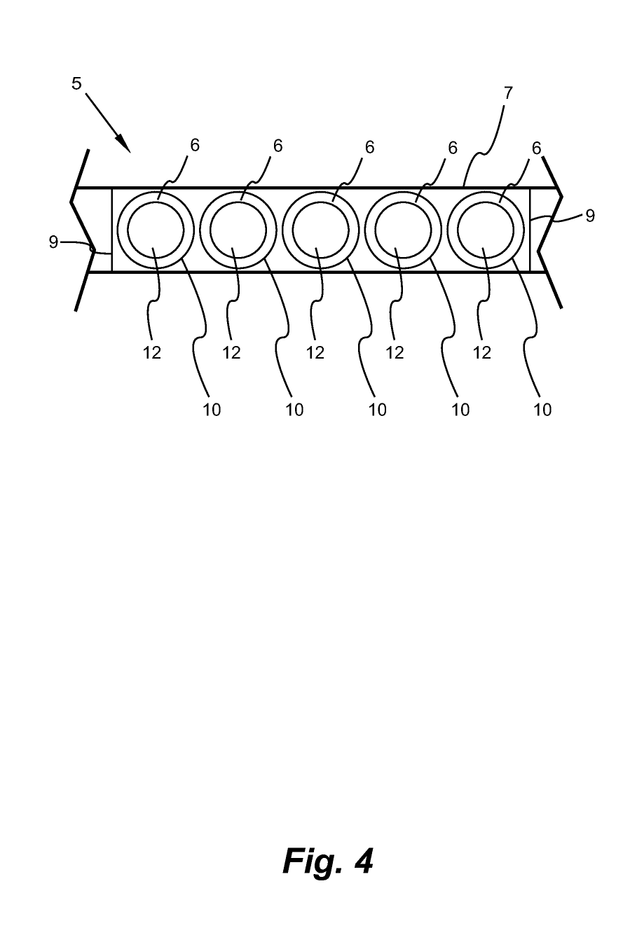

FIG. 3 shows the structure and construction of the membrane contactor layer 2 prior to incorporation into the module. A mat of longitudinally concentrated substantially parallelized hollow fiber membranes 6 is sandwiched between impermeable sheets 7, 8 that can be individual or part of one larger sheet. The sheets 7, 8 can be sealed together by an adhesive resin or glue. Glue lines 9 depict an exemplary configuration of sealing sheets 7 and 8 to form a packet or envelope 5 (as shown in FIG. 4) around the outside of the hollow fiber membranes 6.

One or more of the sheets 7, 8 may define access holes 11 provided to allow condensed distillate to drain from the interstitial spaces 10 spaces between the outside of the hollow fibers membranes and the inner surfaces of the impermeable sheets. In use, holes 11 are typically positioned at the bottom of the module to allow condensed distillate accumulating in the interstitial spaces 10 to drain from the membrane envelope under gravity.

FIG. 4 shows a section of the membrane envelope 5 of the membrane contactor layer 2. The hollow fiber membranes 6 are contained within the membrane envelope 5 and are in fluid communication with the inside of the envelope or the interstitial space 10. The lumens 12 of the hollow fibers 6 are accessible from outside of the membrane envelope 5 in order to provide feed fluid to the membrane contact layer 2. This view shows more clearly that the arrangement provides two defined sets of spaces; a first space is the interstitial space 10 between the outside of the hollow fiber membranes 6 and the inner surfaces of the impermeable sheets 7,8, and the second space is defined by the lumens 12 of the hollow fiber membranes 6. Sheets 7 and 8 can be sealed by glue lines 9. Mass transfer from one space to the other is thus across the wall of the hollow fiber membranes 6. The lumens 12 of all the hollow fiber membranes can ultimately be brought into fluid communication at each respective end by way of manifolds when the module is provided in a distillation apparatus, or other suitable membrane contactor application. One end of the lumens can be connected to a feed inlet or manifold, the other to a feed exit or takeoff manifold.

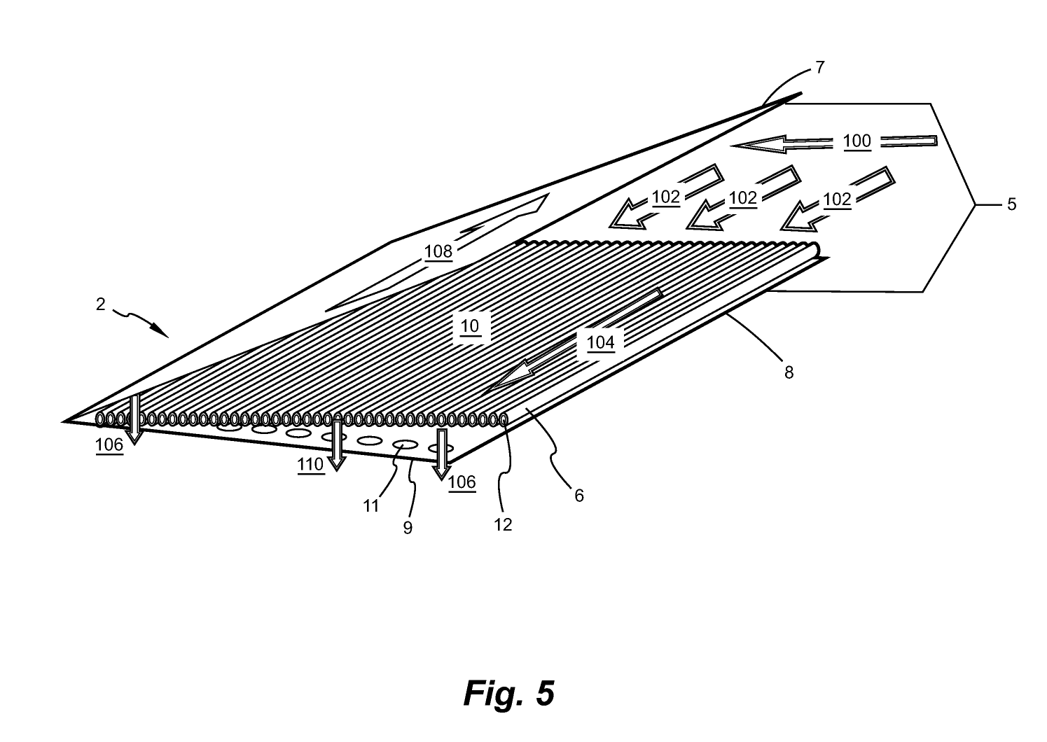

FIG. 5 shows the flow of fluids within the membrane envelope 5, which is shown in an exploded view. Product-rich feed, that is, feed fluid comprising a vapor product and a liquid carrier, which is heated as desired, typically above ambient (22-25° C.) temperature, is conveyed in directions 100 and 102 to the lumens 12 of the hollow fiber membranes 6. As the feed fluid moves along the lumens 12, vapor product crosses the walls of the hollow fiber membranes 6 into interstitial space 10. The vapor condenses in interstitial space 10 due to the cooling effects (caused by coolant traveling generally the direction of 108 while recognizing that the coolant is flowing in a tortuous path) of the condenser region 3, not shown, but which is in closer proximity to the interstitial space than the lumens 12 and drains in directions 104 and 106 via holes 11. The feed fluid is cooled as it passes through the lumens and exits at the other end of the hollow fiber membranes 6 in the direction of 110. The feed fluid also becomes concentrated with respect to non-volatile/liquid carrier components. For instance, if hot sea water is passed through the lumens, it can exit with an increased salt concentration.

In general terms with respect to assembling the module, the central core, spacer sheet, and membrane envelope can be put together in a variety of ways prior to spiral winding. A preferred method disclosed below involves attaching the central core and the spacer sheet, and then applying the membrane envelope. After that, the spacer sheet 13 and the membrane envelope 5 are spiral wound about the core. It may alternatively be desirable to attach the core to the membrane envelope, then apply the spacer mesh and spiral wind. It may be further alternatively desirable to attach the spacer mesh to the membrane envelope and then attach both to the core and spiral wind. A further alternative is to form the contactor in situ on the spacer sheet either before or after attachment to the core. It is also possible to provide a transport tail, which is additional non-functional material, to any of the spacer sheet or membrane envelope or both in order to facilitate winding of these components.

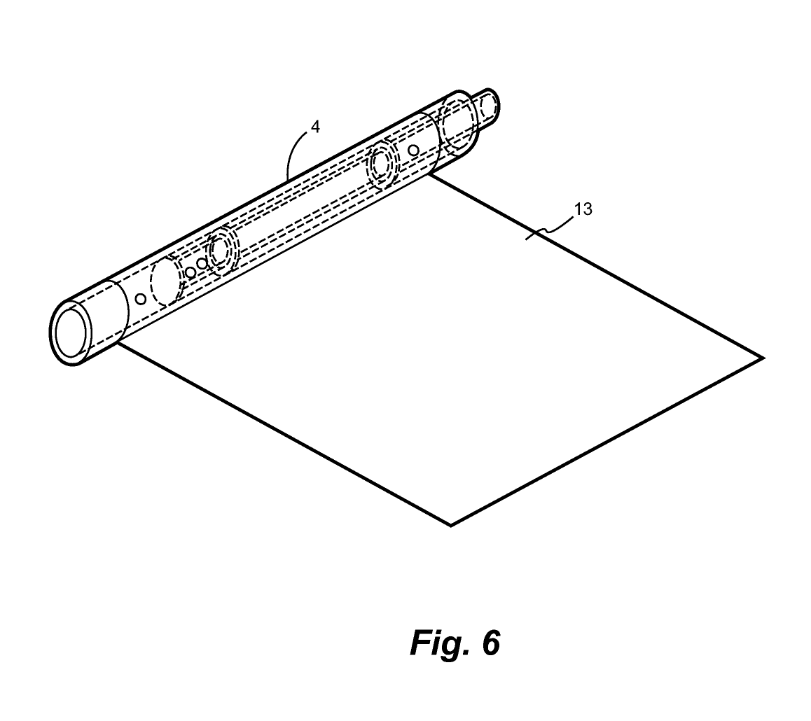

FIG. 6 shows the core 4 attached to the spacer sheet 13 as a first stage of construction. The functions of the various passages in the core can be explained below. Spacer sheet 13 can act as a spacer when the membrane envelope is rolled, to space apart the windings of the membrane envelope and to form a region between respective windings of the membrane envelope to form the condenser region.

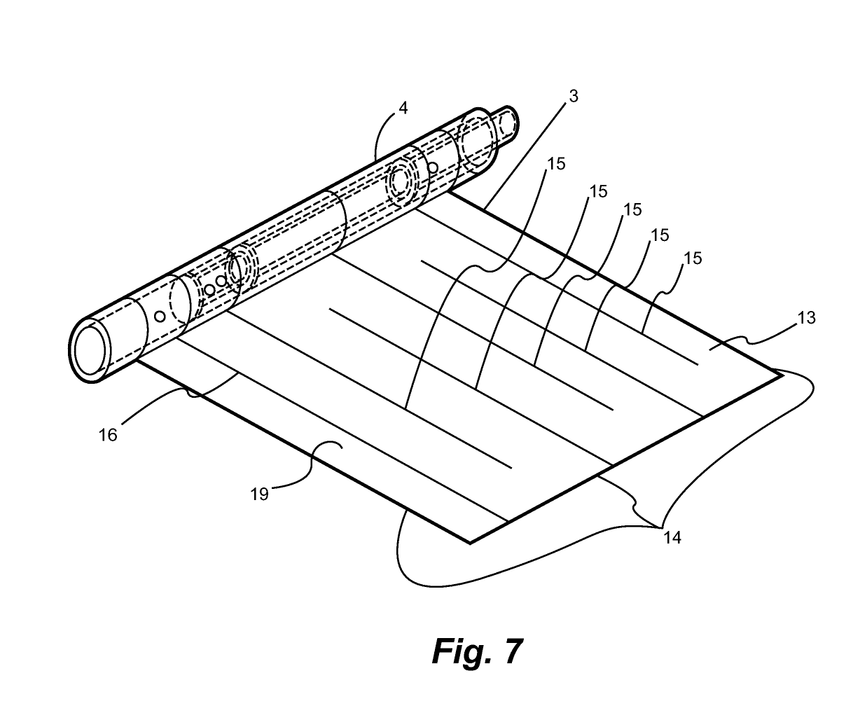

The spacer sheet 13 functions to allow fluids to move between the respective windings of the membrane envelope. This includes moving cooling fluids (e.g., water) through the module to allow heat transfer across the module, but also allows feed and product streams to move in and out of the module. These functions can be achieved by the use of adhesive resin or glue lines which, on rolling, create discrete passages within the condenser or flowpath layer. This is shown more particularly with reference to FIG. 7.

To achieve the controlled flow of fluids within the condenser region or flowpath layer 3, glue lines 14, 15, 16 may be applied to the spacer sheet 13. Upon winding, these glue lines, i) seal the condenser region; (ii) define flow paths of coolant within the condenser region and (iii) create any required ancillary structures. The glue line 14 substantially surrounds the spacer sheet and serves to seal the condenser region when rolled.

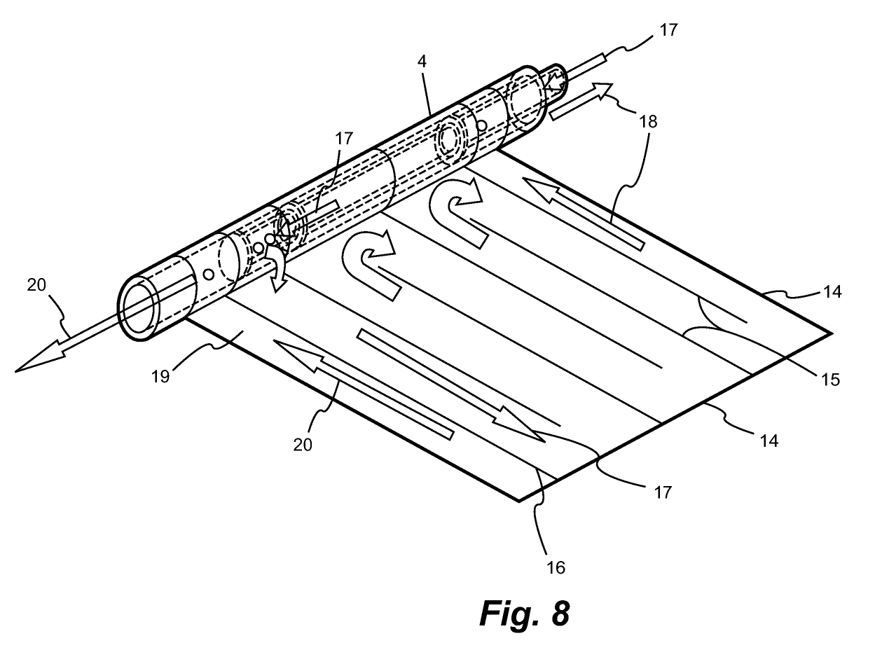

A series of internal glue lines 15 within the condenser region provide a tortuous pathway for coolant when rolled. FIG. 8 shows where coolant (e.g., cool water) 17 enters the core 4 via an inlet coolant conduit at the top and exits the core towards the bottom in order to be introduced into the bottom of the condenser region via a condenser inlet above line 16. Coolant can move along the entire bottom of the condenser region before snaking upwards and again traversing the entire length of the condenser region and so on until it exits the condenser region via a condenser outlet at the top 18, where it passes into the core 4 to be removed via an outlet coolant conduit. Because the whole structure can be rolled, the coolant traverses a series of staged annular or spiral pathways in alternating directions as it moves through the condenser region.

Glue line 16 is also used to form an ancillary structure, which is the gutter 19. This gutter can be aligned with holes 11 in the membrane envelope 5, and allows product distilled from the hollow fiber membranes 6 to collect in this region and be moved to the core 4 to be taken off via a flowpath for distillate collection 20. In this regard, the glue line 16 defines a flowpath or collection manifold to collect and guide a passage of distillate produced through the hollow fiber membrane 6 walls to the core 4 to allow for removal of the distillate.

The functions of the core 4 are illustrated in FIG. 8. As well as providing a support and boss for winding, it contains three distinct and separate fluid pathways. Coolant enters via a first central axial passageway or an inlet coolant conduit 17 and leaves via a second annular pathway or an outlet coolant conduit 18. Distillate is removed via a third lower pathway or flowpath for distillate collection 20.

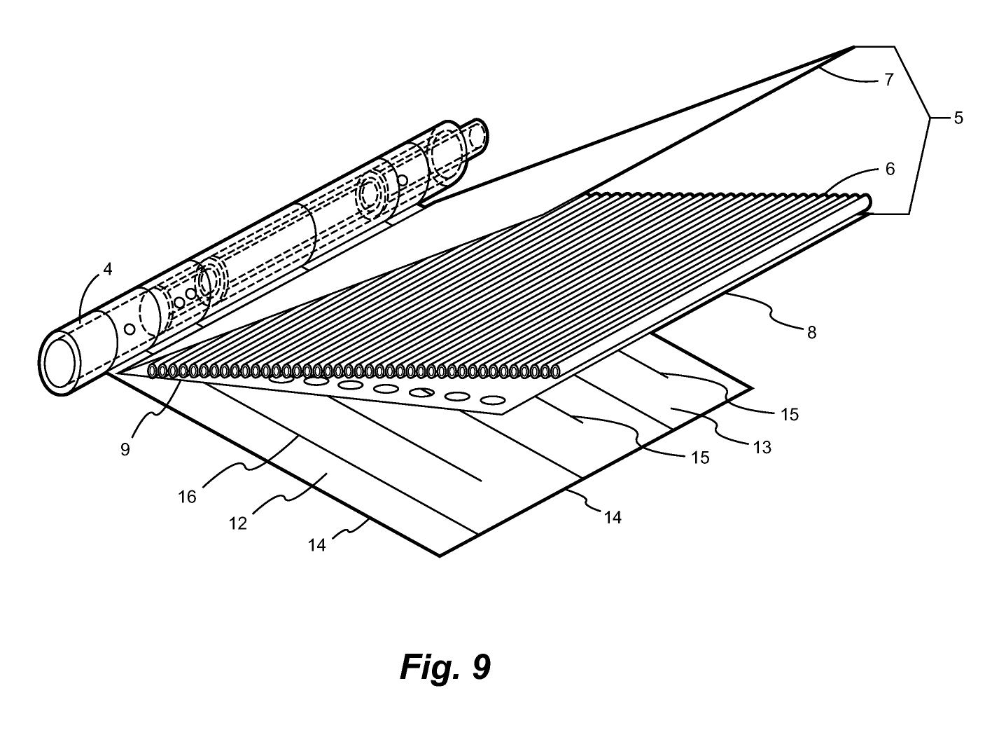

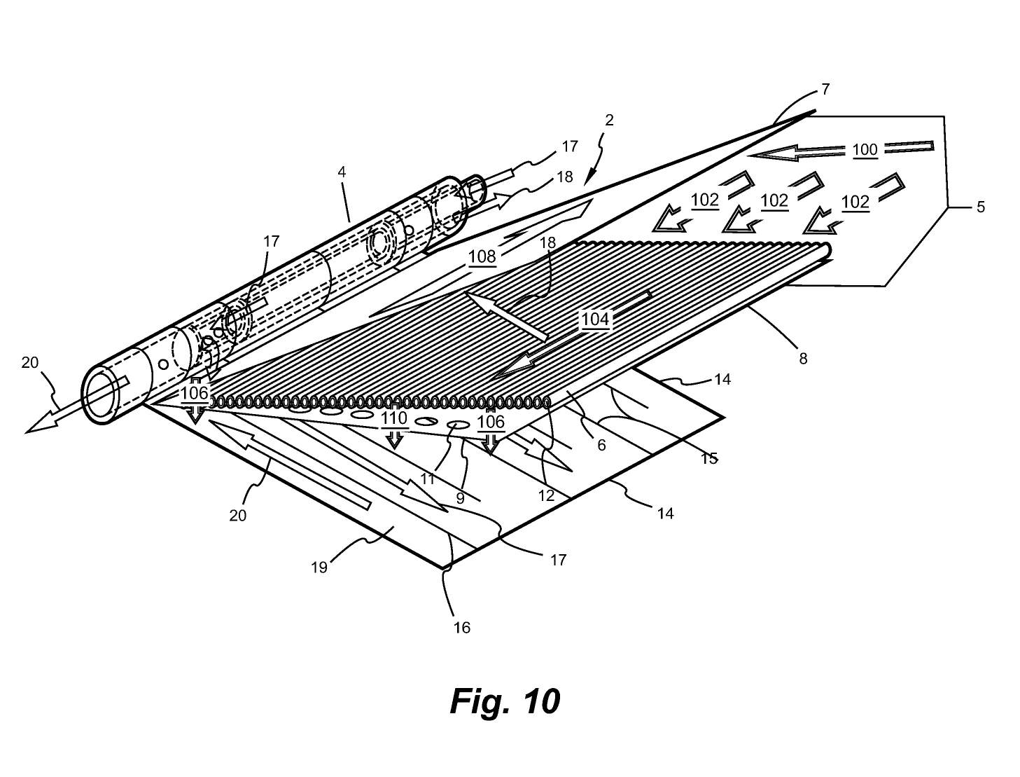

FIG. 9 shows the addition of the membrane contactor layer comprising the membrane envelope 5 and plurality of hollow fiber membranes 6 to the spacer sheet 13 having glue lines 14, 15, and 16 and the core 4. FIG. 10 shows how all the flows within the device may be arranged. The flow of feed water and cooling water can either be countercurrent, cross-current or co-current. Countercurrent is generally preferred.

FIG. 10 shows the flow of fluids within the membrane envelope 5 having impermeable sheets 7, 8, which is shown in an exploded view. Product-rich feed, that is, feed fluid comprising a vapor product and a liquid carrier, which is heated as desired, typically above ambient (approximately 22-25° C.) temperature, is conveyed in directions 100 and 102 to the lumens 12 of the hollow fiber membranes 6. As the feed fluid moves along the lumens 12, vapor product crosses the walls of the hollow fiber membranes 6 into the interstitial space, where the vapor condenses due to the cooling effects caused by coolant traveling generally the direction of 108 (while recognizing that the coolant is flowing in a tortuous path). The condensed vapor drains in direction 106 via holes 11 and flowpath 20. The feed fluid is cooled as it passes through the lumens and exits at the other end of the hollow fiber membranes 6 in the direction of 110. The feed fluid also becomes concentrated with respect to non-volatile/liquid carrier components.

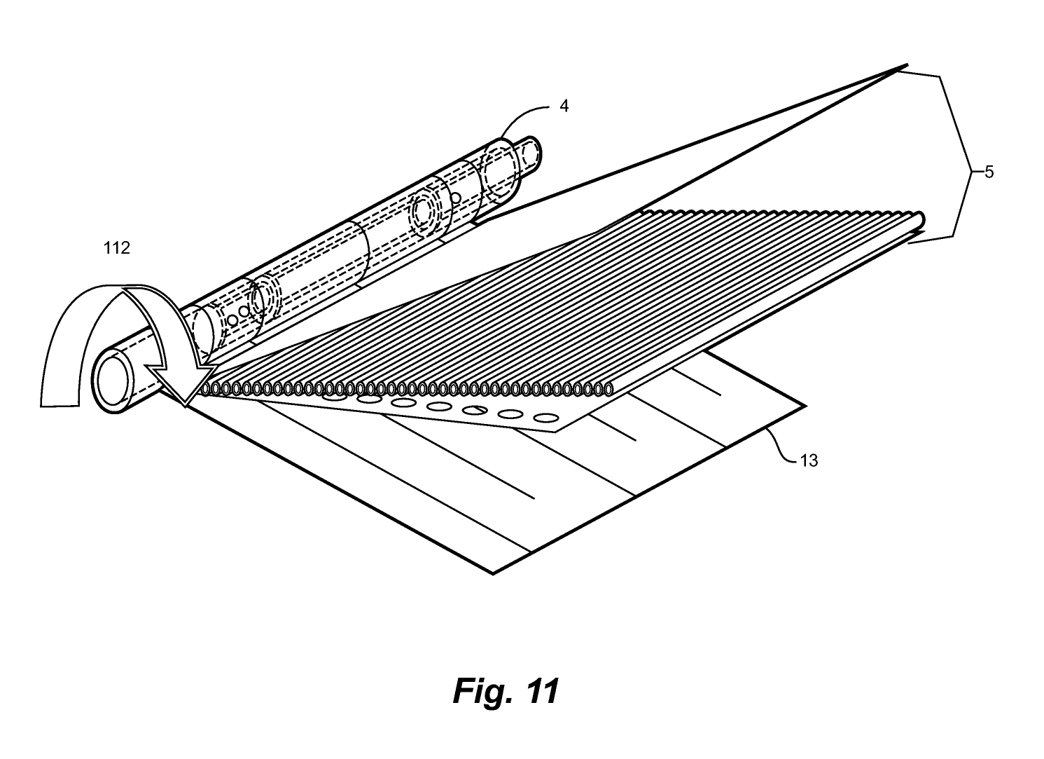

FIG. 11 shows the winding about the core 4 in the direction of 112 to achieve putting the spacer mesh 13 next to the core 4. The membrane envelope 5 and spacer sheet 13 are preferably the same size or substantially the same size. The addition of the membrane contactor layer to the spacer sheet as shown in FIG. 9 can be arranged first, then this combination is attached and rolled about the central core 4. The core 4 preferably extends beyond the perimeter of the condenser layer. This provides an interleaved (or wound) arrangement of the membrane envelope 5 and the condenser region formed of the spacer sheet 13, with the core extending above and below the spiral wound assembly. Once wound, the adhesive resin or glue is allowed to cure and the material is trimmed. The whole may also be wrapped for completeness.

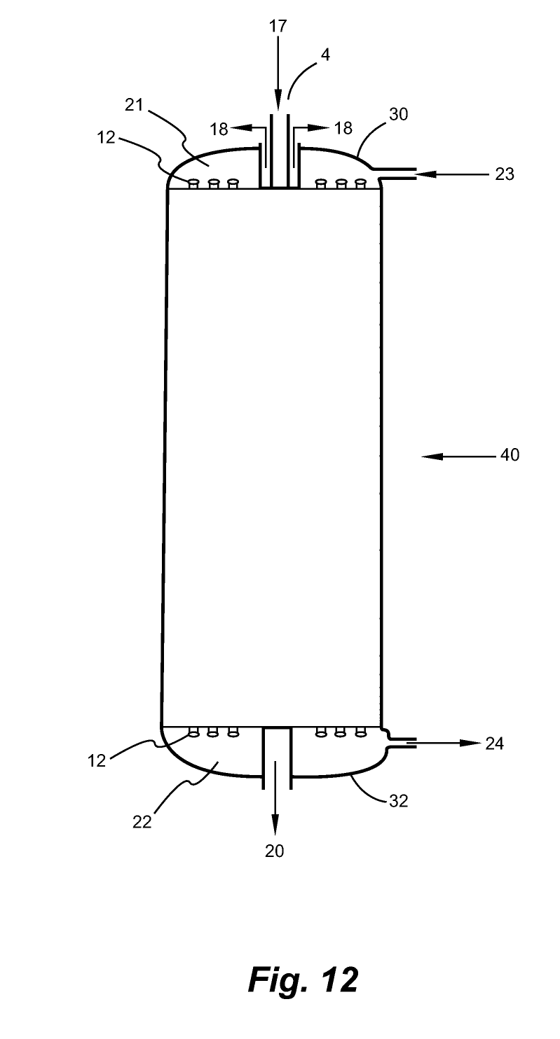

FIG. 12 shows an exemplary final construction of a membrane contactor apparatus 40, such as a membrane distillation unit, including the membrane module. The membrane module can be placed in a shell that has caps 30 and 32, such that exposed lumens 12 top and bottom are in fluid communication with a top manifold 21 in cap 30 to introduce feed stream 23 into the membrane module and with a bottom manifold 22 in cap 32 to removed purified stream (or product-depleted stream) 24 from the membrane module. The feed stream 23 and purified stream 24 are insulated from mass transfer into the distillate stream 20 by the glue lines of the spacer mesh/condenser region. All the lumens are thus in fluid communication and act as a parallel arrangement of a micro distillation apparatus.

The core 4 can be used to introduce coolant into the system 17, to remove coolant out of the system 18, and to collect the distillate 20.

The hollow fiber membrane envelope is mounted vertically during operation as shown in FIG. 12 to allow for gravity drain of the distillate 20. That is, the aligned gutter 19 and holes 11 are located at the bottom of the device.

In an exemplary use, hot feed fluid having water that is desired to be removed is passed into manifold 23 where it then enters the lumens 12 of hollow fiber membranes 6. Vapor pressure leads to diffusion of pure water vapor across the membrane wall. Once the vapor enters interstitial space 10, it comes into contact with the coolant layer 3, and condenses, whereupon it drips to the bottom of the membrane envelope 5, passes through holes 11 into gutter 19 and out central tube 20. The hot fluid in the lumens is insulated by the hollow fibers 6 themselves and by interstitial space 10 from the coolant condenser layer 3.

In use, coolant (usually water) is also passed into a first section of the tube 17. The coolant fluid flows along tortuous paths defined by glue lines 15. This maximizes coolant time in the condenser region 3.

### Example 2A

### Distillate Collected by Permeate Fluid

The spiral wound module can also be used to collect the distillate directly into a permeate fluid, which is preferably cooled. In this mode of use, a heated feed stream contacts one side of the hollow fiber membrane and a cooled permeate fluid contacts the other. The distillate moves directly into the cooled permeate fluid due to a difference in partial vapor pressure across membrane. The hot feed can either contact the outer side of the hollow fibers or the lumens. Embodiments of the present invention are described in relation to an embodiment where hot feed enters the lumens.

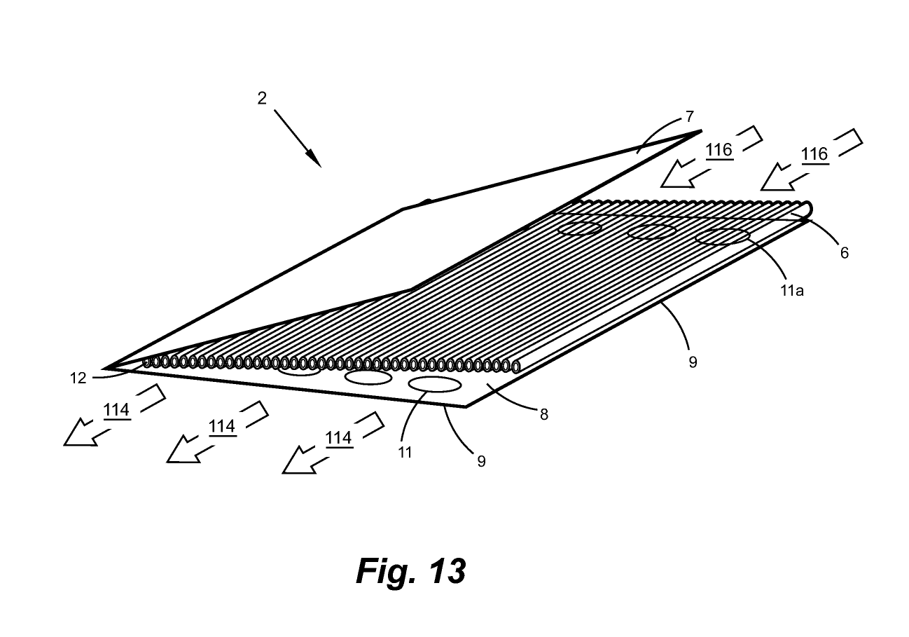

FIG. 13 shows the structure and construction of the membrane contactor layer 2 prior to incorporation into the module. A mat of hollow fiber membranes 6 that are longitudinally concentrated substantially parallelized is sandwiched between two sheets 7, 8 that can be permeable or impermeable. Sheets 7 and 8 may be part of one larger sheet that is folded over. If the sheets are impermeable, then the fluid flow in the interstitial space and the condenser region are not commingled. When the sheets are permeable, they are desirably made of a mesh, and in an exemplary embodiment, the mesh is finer than that of the spacer sheet or sheets. The use of mesh to form the sheets of the membrane envelope allows for complete use of the spacer mesh in the condenser region. In one or more embodiments, the mesh screen for the membrane envelope has one or more of the following properties: mesh opening: 100-150 μm; open area 30-50%; thickness 50-200 μm; wire diameter 5-100 μm. Suitable commercial products for the mesh of the membrane envelope are, but not limited to: Sefar #07-105/118; Sefar #07-120/50; Sefar #07-120/34; Sefar #07-85/46. In one or more embodiments, the spacer sheets are formed of mesh having one or more of the following properties: mesh opening: 500-2000 μm; open area 30-50%; thickness 500-1500 μm; wire diameter 5-1000 μm. Suitable commercial products for the mesh of the spacer sheets include, but are not limited to: Sefar #05-1001-WBC; Sefar #04-1010-WBC; Sefar #06-2000-53. The sheets are held together by glue line 9, which forms an envelope around the outside of the hollow fiber membranes 6.

In this embodiment, one or more of the sheets 7, 8 may have two areas of access holes 11, 11a provided to allow inflow and outflow of the permeate fluid into the interstitial spaces 10 spaces between the outside of the hollow fibers membranes and the inner faces of the permeable sheets. The access holes 11a and 11 are located such that they can be at the top and bottom of the module respectively when it is formed and in use. Because the permeate fluid is cooled, it can directly assist in the condensation of product that crosses the hollow fiber membranes 6. It is not necessary for this embodiment to have a condenser, or even to be spiral wound, but it is still advantageous to have the permeate fluid cooled as this increases the difference in partial vapor pressure between the feed side and the distillate side of the membrane, enhancing the passage of the product across the membrane.

As shown in FIG. 13, product-rich feed, which is heated, enters the lumens 12 in direction 116 and the product-depleted stream exits the lumens in direction 114, where product vapor passes across the wall of hollow fiber membranes 6 into interstitial space 10. The vapor contacts cooled permeate fluid in interstitial space 10.

The lumens 12 of all the hollow fibers can subsequently be in fluid communication at each respective end. One end can thus be connected to a feed manifold, the other to a takeoff manifold.

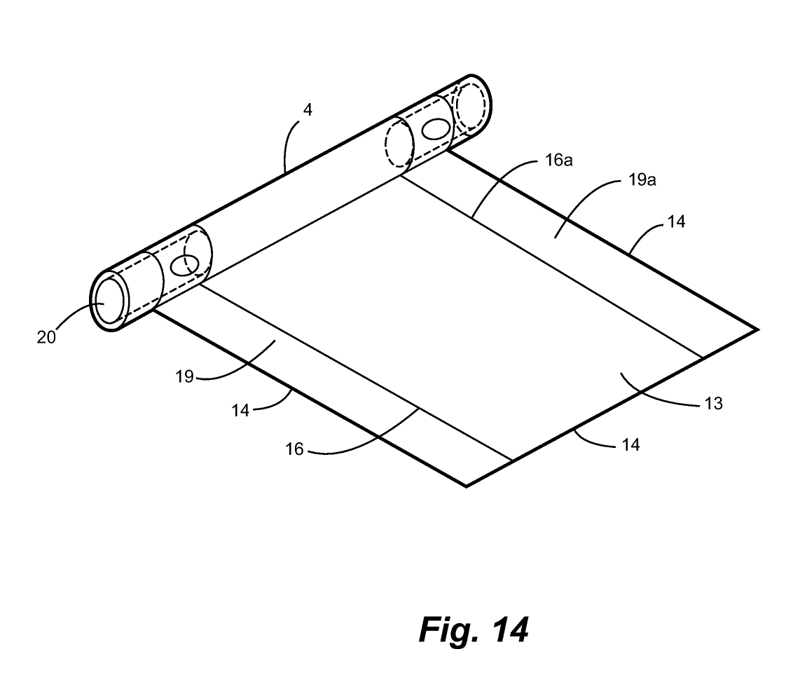

The glue lines in this embodiment are simpler than in the previous embodiment as can be seen in FIG. 14, which shows the spacer sheet 13 attached to the central core 4. Glue lines 14, 16, and 16a are applied to the spacer sheet 13 to, on rolling, i) seal the condenser layer; and (ii) create any required ancillary structures.

The glue line 14 can serve to seal the condenser when rolled. Glue lines 16 and 16a are also used to provide ancillary structures, which are the gutters or conduits 19 and 19a, respectively. These guide the flow of product-poor permeate fluid into the interstitial spaces 10 via 19a and guide product enriched permeate fluid out of the interstitial spaces 10 and into the core via 19. Gutters or conduits 19 and 19a are aligned with the holes 11 and 11a, respectively, in the membrane envelope 5, and allows product enriched permeate fluid to ultimately exit the module via 20. In this regard, the glue lines 16 and 16a define distribution and collection manifolds respectively to control the passage of permeate fluid in the membrane contactor.

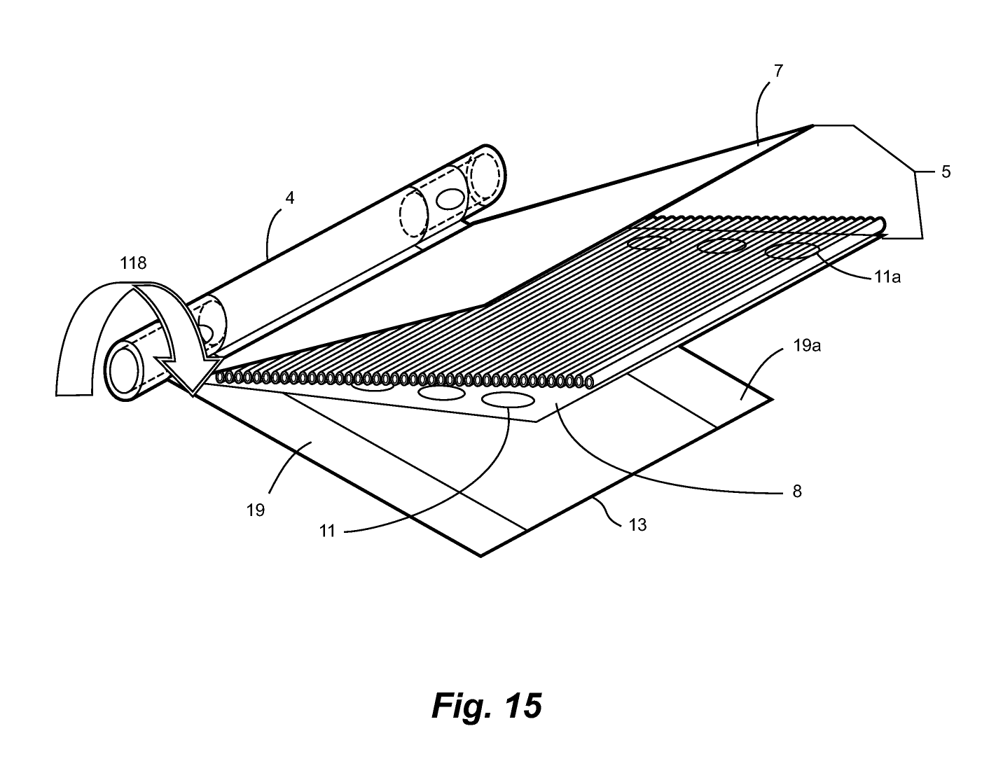

In this case, central core 4 has an entry conduit at the top to lead into an upper gutter 11a and an exit conduit at the bottom in fluid communication with a lower gutter 11. This can act as a spacer when the membrane envelope 5 is rolled as shown in FIG. 15, and can form the space between layers of the spiral to form the flowpath layer.

FIG. 15 shows the winding about the core 4 in the direction of 118 to achieve putting the spacer mesh 13 next to the core 4. The membrane envelope 5 and spacer sheet 13 are preferably the same size or substantially the same size. The arrangement of FIG. 14 in combination with FIG. 13 can be formed first, then attached and rolled about the central core 4. The core 4 preferably extends beyond the perimeter of the condenser layer 3. This provides an interleaved (or wound) arrangement of membrane envelope 5 and the condenser layer 3, with the core extending above and below the spiral wound assembly.

The core in this example can have conduits to allow for the flow of permeate fluid into the interstitial spaces and collection of the product enriched permeate flow as it exits the interstitial spaces.

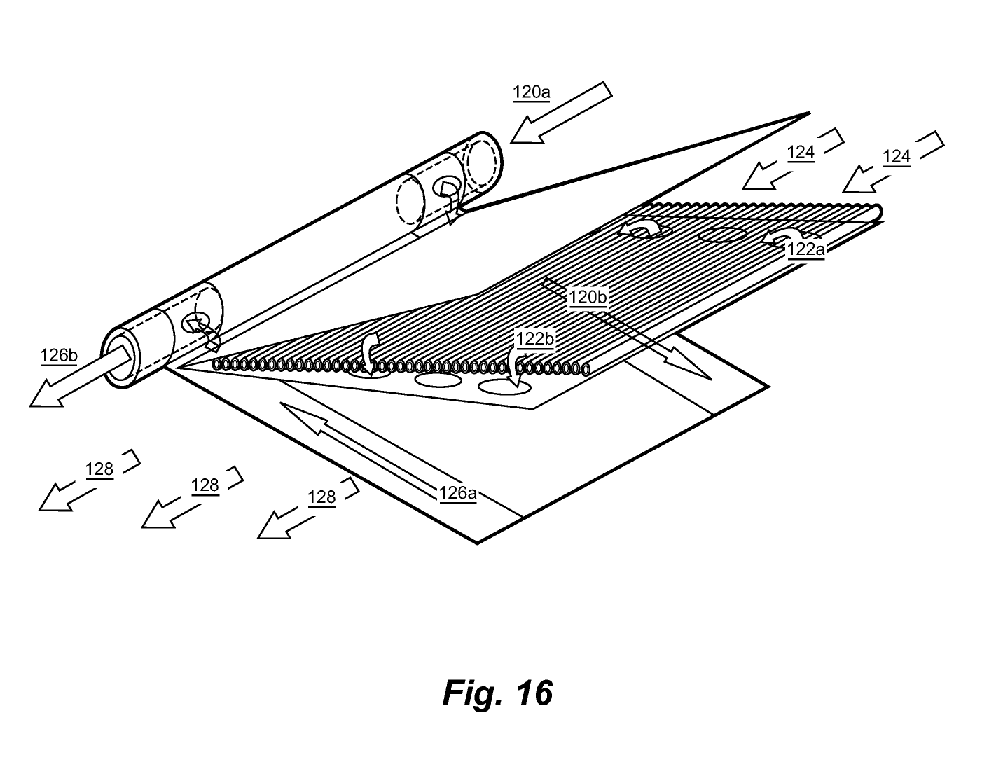

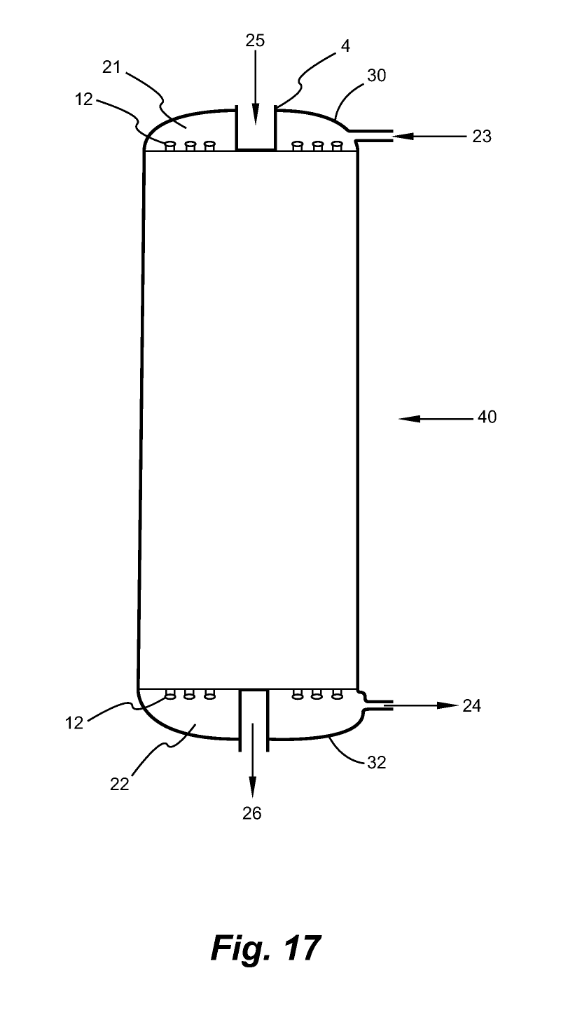

FIG. 16 shows flows in the membrane module and FIG. 17 shows the final construction of a membrane contactor apparatus such as a membrane distillation unit 40 containing the membrane module. The exposed lumens 12 top and bottom can be capped to provide a top manifold 21 capped by 30 and a bottom manifold 22 capped by 32 to introduce crude feed stream 23 into the membrane module in direction 124 and to remove stream 24 in direction 128 from the membrane module. Permeate stream enters at 25 via in direction 120a, and moves via gutter 19a in direction 120b through holes 11a that can serve as an inlet permeate manifold in direction 122a into interstitial space 10, where it can become enriched with product before exiting interstitial space 10 via holes 11 in direction 122b into gutter 19 in direction 126a and then through central core 4 in direction 126b where it leaves via 26. The feed stream 23 and exit stream 24 are insulated from mass transfer into the permeate stream 20 by the glue lines of the spacer mesh/condenser layer. All the lumens are thus in fluid communication and act as a parallel arrangement of micro distillation apparatus.

In use, hot feed fluid is passed into manifold 23 where it then enters the lumens 12 of membranes 6. Vapor pressure leads to diffusion of pure product vapor across the membrane wall. Once the product vapor enters interstitial space 10, it comes in closer contact with the permeate fluid which has been introduced into the interstitial space. An additional coolant layer may be added if desired. The product vapor then mixes with the permeate fluid which flows through holes 11 into gutter 16 and out central tube 20. The hot fluid in the lumens is insulated by the fibers 6 themselves from the coolant in the condenser region 3.

### Example 2B

### Distillate Collected by Permeate Fluid

Embodiments of the present invention are now described in relation to an embodiment where hot feed contacts the outer side of the hollow fibers.

In this embodiment, one or more of the sheets 7, 8 may have two areas of access holes 11, 11a provided to allow inflow and outflow of the hot feed fluid into the interstitial spaces 10 spaces between the outside of the hollow fibers membranes and the inner faces of the permeable sheets. The access holes 11a and 11 are located such that they can be at the top and bottom of the module respectively when it is formed and in use. Access holes may not be desired in embodiments where the sheets 7, 8 are mesh. In this embodiment, product crosses from the interstitial space into the lumens 12 of the hollow fiber membranes 6. It is not necessary for this embodiment to have a condenser, or even to be spiral wound.

The lumens 12 of all the hollow fibers can subsequently be in fluid communication at each respective end. All of the ends can thus be connected to a product takeoff manifold. As desired for piping and fluid flow efficiencies, one end of the lumens can be blocked off to route the product to one end and a single takeoff manifold. At this point, the product can be collected as either a vapor or a liquid. As desired, one set of ends of the lumens can receive a permeate fluid for condensing and carrying the vapor product out of the module.

Glue line 14 in this embodiment can serve to seal the condenser region when rolled. Glue lines 16 and 16a are also used to provide ancillary structures, which are the gutters or conduits 19 and 19a, respectively. These guide the flow of product-rich feed fluid into the interstitial spaces 10 via 19a and guide product-depleted feed fluid out of the interstitial spaces 10 and into the core via 19. Gutters or conduits 19 and 19a are aligned with the holes 11 and 11a, respectively, in the membrane envelope 5, and allows product-depleted feed fluid to ultimately exit the module via 20. In this regard, the glue lines 16 and 16a define distribution and collection manifolds respectively to control the passage of feed fluid in the membrane contactor.

The core in this example can have conduits to allow for the flow of feed fluid into the interstitial spaces and collection of the product-depleted feed fluid as it exits the interstitial spaces.

FIG. 16 shows flows in the membrane module for this embodiment where hot feed fluid enters the core in direction 120a, and moves via gutter 19a through holes 11a and/or through mesh screens 7, 8 into the interstitial space 10, where it can become depleted with product before exiting interstitial space 10 via holes 11 in direction 122b into gutter 19 in direction 126a and then through central core 4 in direction 126b. Product flows through the hollow fiber walls into the lumens by vapor pressure. The product then can either be collected by condensation into a permeate fluid flowing through the lumens or transported as a vapor for condensation outside the module.

### Example 3

### Heat Exchanger

The construction of a heat exchanger is identical to that in Example 2, except that the hollow fiber membranes are non permeable. Heated fluid flows in one discrete flow path and cooled fluid flows in another. Heat, but not mass, is exchanged across the membranes. In one embodiment, heated liquid is introduced at 25 or 26 and cool fluid is introduced at 23 or 24. In another embodiment, heated liquid is introduced at 23 or 24 and cool fluid is introduced at 25 or 26. As is usual with heat exchangers, the initially cool fluid is heated during the process and the initially hot fluid is cooled. The membranes are preferably of a high conductivity.

While the invention has been disclosed in exemplary forms, it will be apparent to those skilled in the art that many modifications, additions, and deletions can be made therein without departing from the spirit and scope of the invention and its equivalents, as set forth in the following claims.

What is claimed is:

1. A membrane module for use in membrane contactor applications, the membrane module comprising:
a membrane contactor layer comprising a membrane envelope and a plurality of hollow fiber membranes disposed therein;
a feed fluid pathway defined at least in part by lumens of the hollow fibers; and
a permeate fluid pathway defined at least in part by an interstitial space between outer surfaces of the hollow fibers and inner surfaces of the membrane envelope.

2. The membrane module according to claim 1 further comprising a condenser region adjacent to the membrane contactor layer.

3. The membrane module according to claim 1, wherein the membrane envelope comprises one or more impermeable sheets.

4. The membrane module according to claim 1, wherein the membrane envelope comprises one or more permeable sheets.

5. The membrane module according to claim 2, wherein the membrane contactor layer and the condenser region share a common wall capable of transferring heat.

6. The membrane module according to claim 2, wherein the membrane contactor layer is spiral wound and the condenser region is defined by a space between respective windings of the membrane envelope.

7. The membrane module according to claim 6, wherein the condenser region comprises one or more spacer sheets to space apart the respective windings of the membrane envelope.

8. The membrane module according to claim 1, wherein first ends of the lumens are in fluid communication with an inlet feed manifold and second ends of the lumens are in fluid communication with an exit feed manifold.

9. The membrane module according claim 1, wherein the permeate fluid pathway is in fluid communication with a flowpath for distillate collection.

10. The membrane module according to claim 9, wherein the permeate fluid pathway is in further fluid communication with an inlet permeate manifold.

11. The membrane module according claim 2, wherein the condenser region comprises a condenser inlet, a condenser outlet and a coolant pathway therebetween.

12. The membrane module according to claim 11 wherein the condenser region comprises one or more internal baffles to provide a tortuous coolant pathway.

13. The membrane module according to claim 12, wherein the tortuous coolant pathway is provided by glue lines on one or more spacer sheets or on exterior surfaces of the membrane envelope or both.

14. The membrane module according to claim 2, wherein the membrane contactor layer is spiral wound about a central core.

15. The membrane module according to claim 14, wherein the central core comprises an inlet coolant conduit for introducing coolant to the condenser region and an outlet coolant conduit for removing coolant from the condenser region.

16. The membrane module according to claim 14, wherein the central core comprises a distillate conduit for removing distillate from the permeate fluid pathway via holes in the membrane envelope.

17. The membrane module according to claim 14, wherein the central core comprises an inlet permeate conduit for introducing a product-poor permeate stream into the interstitial space and an outlet permeate conduit for removing product-rich permeate stream from the interstitial space.

18. A membrane distillation apparatus comprising the membrane module according to claim 1 located in a shell having a feed inlet in fluid communication with first ends of the lumens and a feed exit in fluid communication with second ends the lumens, wherein the hollow fiber membrane envelope is mounted vertically during operation to allow for gravity drain of distillate or product-rich permeate.

19. A method of making a membrane module for use in membrane contactor applications comprising:
forming a mat of hollow fiber membranes;
positioning the mat of hollow fiber membranes in a membrane envelope;
substantially sealing the membrane envelope around the mat of hollow fiber membranes to form a feed fluid pathway defined at least in part by lumens of the hollow fiber membranes and a permeate fluid pathway defined at least in part by interstitial space between outer surfaces of the hollow fiber membranes and inner surfaces of the membrane envelope; and
spiral winding the membrane envelope to define a condenser region between respective windings of the membrane envelope.

20. The method of claim 19 further comprising including one or more spacer sheets in the condenser region to space apart the respective windings of the membrane envelope.

21. The method of claim 20, further comprising applying one or more glue lines on one or more spacer sheets or on exterior surfaces of the membrane, or both prior to spiral winding to form a tortuous coolant path within the condenser region.

22. The method according to claim 19 further comprising spiral winding the membrane envelope and around a central core.

23. A method of using a hollow fiber module in membrane distillation comprising:
passing a feed fluid comprising a vapor product and a carrier liquid into lumens of a plurality of hollow fiber membranes disposed in a membrane envelope;
collecting the vapor product that crosses the hollow fiber membranes from the feed fluid into an interstitial space defined by outer surfaces of the hollow fiber membranes and inner surfaces of the membrane envelope; and
removing an exit stream that contains less product than the feed fluid from the lumens.

24. The method according to claim 23 wherein the feed fluid is at a temperature that is greater than ambient.

25. The method according to claim 23 further comprising condensing the vapor product and removing the condensed vapor product.

26. The method according to claim 23 wherein the condensing step comprises contacting the membrane envelope with a coolant.

27. The method according to claim 25 wherein the step of removing the condensed vapor product comprising flowing the condensed vapor product as distillate out of the module under gravity.

28. The method according to claim 25 wherein the step of removing the condensed vapor product comprising flowing the condensed vapor product in a product-enriched permeate stream out of the module under gravity.

29. The method according claim 25 wherein the coolant exits the condenser region at a temperature higher than a temperature at which it entered the condenser region, and the feed fluid exits the hollow fiber membranes at a temperature lower than a temperature at which it entered the hollow fiber membranes.

30. A method of using a hollow fiber module in membrane distillation comprising:
passing a feed fluid comprising a vapor product and a carrier liquid into an interstitial space defined by outer surfaces of hollow fiber membranes and inner surfaces of a membrane envelope in which the hollow fiber membranes are disposed;
collecting the vapor product that crosses the hollow fiber membranes from the feed fluid into lumens of the hollow fiber members; and
removing an exit stream that contains less product than the feed fluid from the interstitial space.

31. The method according to claim 30 wherein the feed fluid is at a temperature that is greater than ambient.

32. The method according to claim 30 wherein the step of collecting the vapor product comprises condensing the vapor product into a permeate fluid flowing in the lumens.

33. The method according to claim 30 wherein the step of collecting the vapor product comprises removing the vapor product from the module for condensing in an operation external to the module.
